(19) United States
(12) Patent Application Publication
(10) Pub. No.: US 2025/0337577 A1
(43) Pub. Date: Oct. 30, 2025

(54) System and Method for Offloading Security Functionality

(71) Applicant: Dell Products L.P., Round Rock, TX (US)

(72) Inventors: Alex Kulakovsky, Ra'anana (IL); Ittai Haas, Rehovot (IL); Yuval Harduf, Yehud (IL)

(21) Appl. No.: 18/649,592

(22) Filed: Apr. 29, 2024

(51) Int. Cl. H04L 9/32

(52) U.S. Cl. CPC H04L 9/3213

(57) ABSTRACT

A method, computer program product, and computing system for offloading security functionality in a data storage system. An authentication request is received at a gateway of the data storage system from a client for establishing a trusted connection between the client and the data storage system. The gateway transfers the authentication request to a remote management system for processing by the remote management system. Upon approval of the authentication request, the gateway receives an authentication token from the remote management system and the gateway transfers the authentication token to the client for use in subsequent access requests to the data storage system.

### BACKGROUND

Cloud-based data storage systems may include, for example, a disk array enclosure having multiple disk drives such that the amount of memory available on the system is expandable and also able to be divided among multiple clients. While such a system includes multiple physical memory devices, the system may be configured such that multiple storage devices of the storage system can be represented to a client as a single storage entity. Since multiple clients may have access to storage devices in the storage system, it is important to maintain the security of the client's information across the data storage system. This security function may be facilitated by a dedicated security function within the data storage system. However, operation of such a system can be expensive and utilize system bandwidth to the detriment of overall efficiency and latency.

### SUMMARY OF DISCLOSURE

In one example implementation, a computer-implemented method executed on a computing device may include, but is not limited to, receiving, at a gateway of a data storage system, an authentication request from a client for establishing a trusted connection between the client and the data storage system; the gateway transferring the authentication request to a remote management system for processing by the remote management system; upon approval of the authentication request, the gateway receiving an authentication token from the remote management system and transferring the authentication token to the gateway; and the gateway transferring the authentication token to the client for use in subsequent access requests to the data storage system.

One or more of the following example features may be included. The remote management system may include a baseboard management controller (BMC). The gateway may include a dedicated management interface. The dedicated management interface may include a Redfish interface. The method may further include receiving, at the gateway, a query from the client, wherein the query includes the authentication token; the gateway sending a command, including the authentication token, to the remote management system for verification; upon verification of the authentication token, the gateway receiving a success message from the remote management system, indicating that the authentication token included with the query is verified; and the gateway transmitting the query to access a service of the data storage system. The service may transmit a response to the query to the client. The command may include a status command. The remote management system may include a remote application programming interface (API). The remote API may include a RESTful API.

In another example implementation, a computer program product resides on a computer readable medium that has a plurality of instructions stored on it. When executed by a processor, the instructions cause the processor to perform operations that may include, but are not limited to, receiving, at a gateway of a data storage system, a query from a client, wherein the query includes an authentication token; the gateway sending a command, including the authentication token, to a remote management system for verification; upon verification of the authentication token, the gateway receiving a success message from the remote management system, indicating that the authentication token included with the query is verified; and the gateway transmitting the query to access a service of the data storage system.

One or more of the following example features may be included. The service may include transmitting a response to the query to the client. The command may include a status command. The remote management system may include a remote application programming interface (API). The remote API may include a RESTful API. The computer program product may further include receiving, at the gateway of the data storage system, an authentication request from the client for establishing a trusted connection between the client and the data storage system; the gateway transferring the authentication request to the remote management system for processing by the remote management system; upon approval of the authentication request, the gateway receiving the authentication token from the remote management system; and the gateway transferring the authentication token to the client for use in subsequent access requests to the data storage system. The remote management system may include a baseboard management controller (BMC). The gateway may include a dedicated management interface. The dedicated management interface may include a Redfish interface.

In another example implementation, a computing system including a memory and a processor is configured to perform operations that may include, but are not limited to, receiving, at a gateway of a data storage system, an authentication request from a client for establishing a trusted connection between the client and the data storage system; transferring the authentication request from the gateway to a remote management system for processing by the remote management system; upon approval of the authentication request, the gateway receiving an authentication token from the remote management system; the gateway transferring the authentication token to the client for use in subsequent access requests to the data storage system; receiving, at the gateway of the data storage system, a query from the client, wherein the query includes the authentication token; the gateway sending a command, including the authentication token, to the remote management system for verification; upon verification of the authentication token, the gateway receiving a success message from the remote management system, indicating that the authentication token included with the query is verified; and the gateway transmitting the query to access a service of the data storage system. The remote management system may include a baseboard management controller.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system and a security offloading process coupled to a distributed computing network according to one or more example implementations of the disclosure;

FIG. 2 is an example depiction of a system and process for offloading security functionality in a data storage system;

FIG. 3 is an example flowchart of the security offloading process according to one or more example implementations of the disclosure;

FIG. 4 is an example depiction of a system and process for offloading security functionality in a data storage system; and

FIG. 5 is an example flowchart of the security offloading process according to one or more example implementations of the disclosure.

Like reference symbols in the various drawings indicate like elements.

### DETAILED DESCRIPTION

### System Overview:

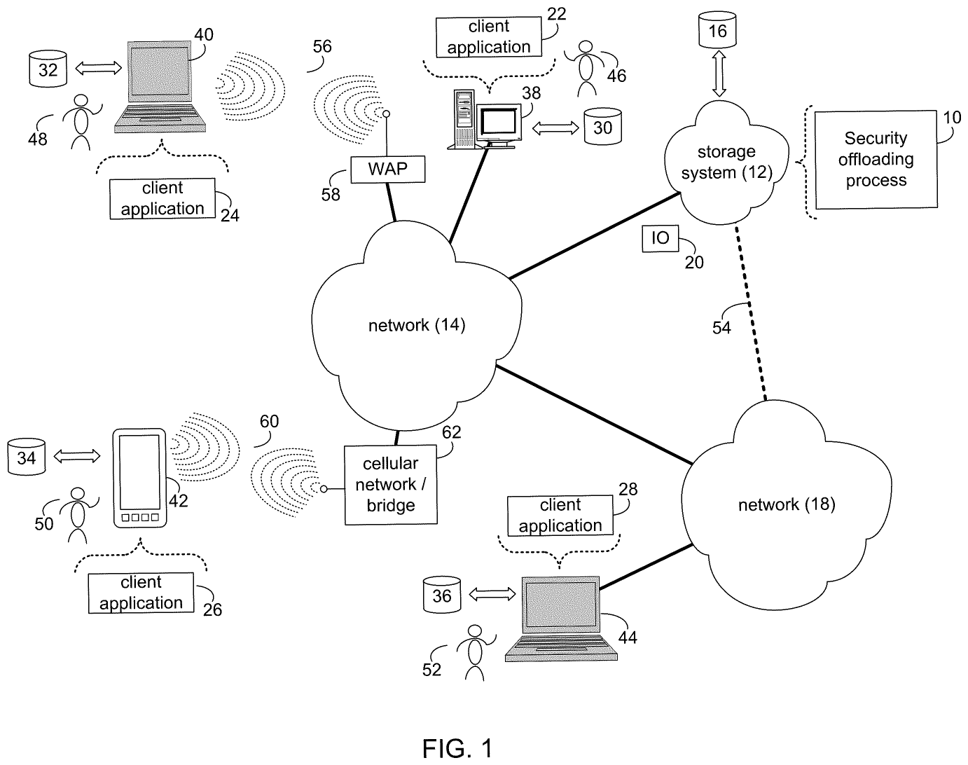

Referring to FIG. 1, there is shown security functionality offloading process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a mini computer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of disability access assistance process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random access memory (RAM); a read-only memory (ROM); and all forms of flash memory storage devices. Additionally/alternatively, some portions of the instruction sets and subroutines of disability access assistance process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g. IO request 20) may be sent from client applications 22, 24, 26, 28 to storage system 12. Examples of IO request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a data deduplication process, such as virtual entry lifetime expansion process 10 of FIG. 1, may include but is not limited to, monitoring a deduplication function of a virtual layer of a data storage system, incrementing a reference count of a virtual entry when a data page is written to the virtual layer, decrementing the reference count of the virtual entry when a data page is deleted from the virtual layer, maintaining the virtual entry in the virtual layer when the reference count reaches a predetermined value, and reclaiming the virtual entry when a predetermined action of the data storage system is to be performed.

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### The Security Functionality Offloading Process

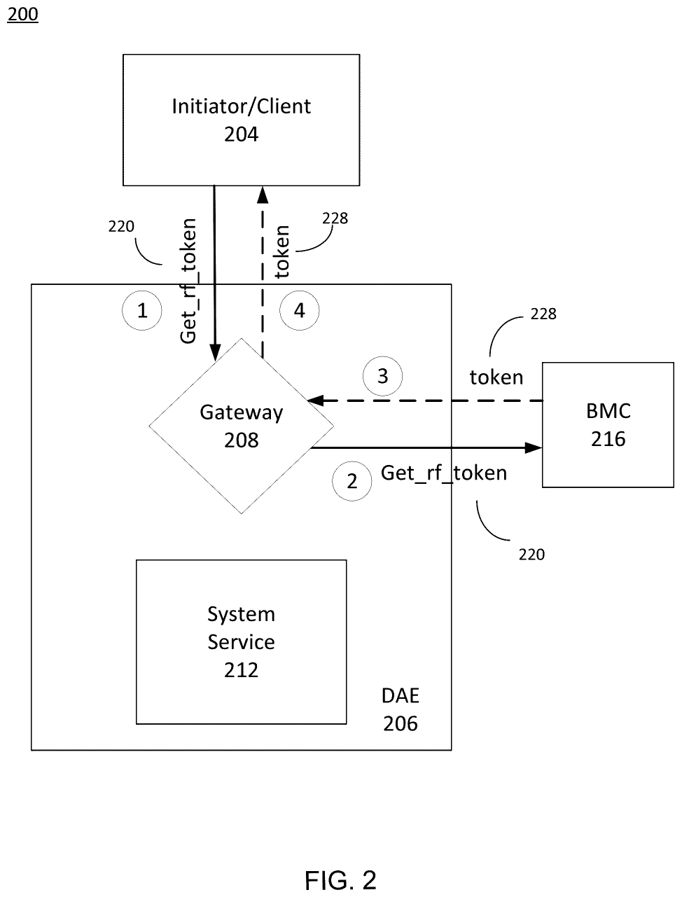

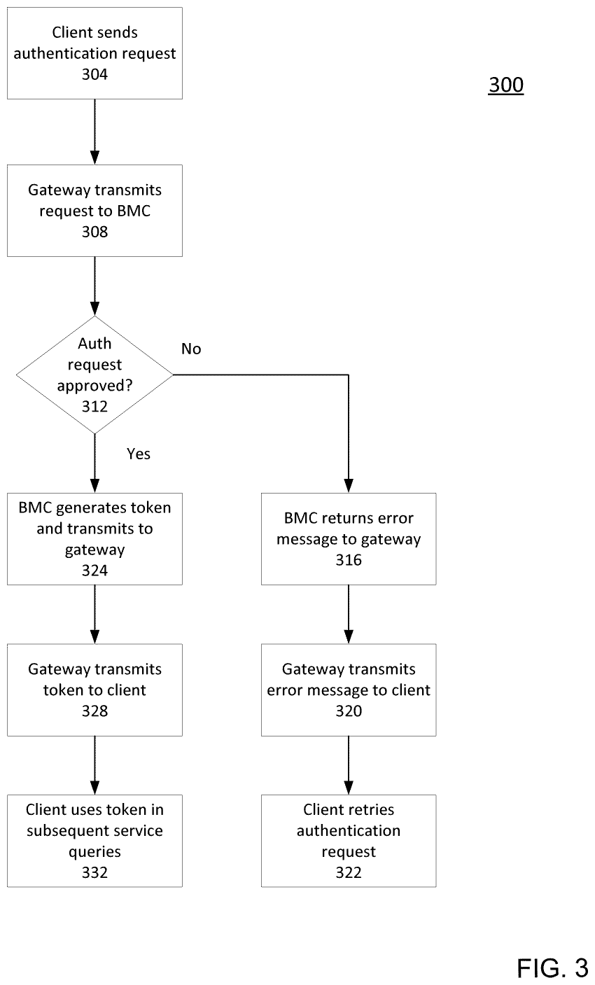

FIGS. 2 and 3 are an example graphical representation 200 and a flowchart 300, respectively, of a system and process for offloading security functionality of a data storage system. System 200 includes an initiator/client device 204, a disk array enclosure (DAE) 206, and a baseboard management controller (BMC) 216. DAE 206 may include an enclosure having multiple (e.g., 44) solid state drive (SSD) devices (not shown) in an enclosure. These enclosures are commonly used in data storage systems, such as network-attached storage (NAS), direct-attached storage (DAS), and storage area networks (SANs), to provide a scalable and centralized storage solution. The SSD drives can be configured together as one or more virtual drives offering data storage services to clients.

BMC 216 is a specialized microcontroller embedded on a server's motherboard that provides remote management and monitoring capabilities for the server hardware, even when the server is powered off or unresponsive. BMC 206 acts as an independent subsystem that operates independently of the server's main processor and operating system, enabling administrators to remotely manage and troubleshoot the server's hardware components, such as processors, memory, storage, and network interfaces.

BMC 216 typically includes features such as remote console access, remote power control, hardware monitoring, and out-of-band management capabilities. Through dedicated management interfaces such as, for example, IPMI (Intelligent Platform Management Interface) or Redfish, administrators can remotely access BMC 206 to perform tasks such as accessing the server's console, rebooting the server, updating firmware, monitoring hardware health, and configuring BIOS settings, regardless of the server's operational state.

BMC 216 provides remote management and monitoring capabilities, which is particularly useful in data centers or remote server deployments where physical access to servers may be limited. By leveraging BMC 216, system 200 administrators can reduce downtime, diagnose hardware issues, and perform maintenance tasks without the need for physical presence at the server location, improving overall system reliability and operational efficiency.

System 200 further includes gateway 208 and system service 212. System service 212 includes a software component or process running on the DAE 206 that provides essential functionality and management capabilities for the storage system. System services 212 in DAE 206 are responsible for tasks such as monitoring the health and status of the disk drives, managing storage configurations, handling data redundancy and protection mechanisms, and facilitating communication with external storage controllers or hosts.

One of the primary functions of system services 212 in DAE 206 is to ensure the reliability, availability, and performance of the storage infrastructure. This includes tasks such as monitoring the temperature and operational status of individual disk drives, detecting and alerting administrators to potential hardware failures or issues, and managing the automatic failover and recovery processes in the event of a disk failure or other system fault.

System services 212 in DAE 206 also play a critical role in data management and protection. They may implement RAID (Redundant Array of Independent Disks) configurations to ensure data redundancy and fault tolerance, distribute data across multiple disk drives for performance optimization, and perform data scrubbing or integrity checks to detect and repair errors in stored data.

Additionally, system services 212 in DAE 206 may provide management interfaces and APIs (Application Programming Interfaces) for administrators to configure and monitor the storage system, set up storage volumes or LUNs (Logical Unit Numbers), and perform other administrative tasks. These interfaces may include command-line tools, web-based management consoles, or integration with storage management software platforms.

Gateway 208 serves as an intermediary between the storage infrastructure and the client 204 applications or users accessing the data. Essentially, it acts as a bridge that enables communication and data transfer between the storage devices and the client-side systems. Gateways are often used in storage architectures that involve different types of storage technologies or protocols, allowing them to work together seamlessly.

One common use case for gateways is in cloud storage environments. In this scenario, gateway 208 acts as a local cache or proxy for data stored in the cloud. Client applications interact with the gateway as if it were a local storage device, while the gateway 208 manages the actual storage and retrieval of data from the cloud storage service. This approach allows organizations to take advantage of the scalability and flexibility of cloud storage while maintaining compatibility with existing applications and protocols.

Gateway 208 can also provide protocol translation and data transformation services, allowing clients to access data stored in one format or using one protocol while the data is stored in a different format or using a different protocol. For example, gateway 208 may translate between file-based access protocols like NFS or SMB and block-based storage protocols like iSCSI or Fibre Channel, enabling clients to access storage resources using their preferred method.

When a client 204 needs to establish a trusted connection with DAE 206, it sends an authentication request “get_rf_token” 220 to gateway 208, 304. Request 220 may include username and password information, or any information required for the system to be able to authenticate the user. Information specific to the client may be included in, for example, an HTTP header of the request 220. Gateway 208 transmits the request 220 to BMC 216, 308 for to verify the client and authenticate the request.

In an embodiment of the disclosure, BMC 216 may operate according to any remote application programming interface (API). A remote API is a set of protocols, tools, and definitions that allows software applications to communicate and interact with each other over a network, typically the internet. Unlike traditional APIs that are accessed locally within the same process or system, remote APIs enable applications to make requests and exchange data with remote systems or services hosted on different machines or servers.

Remote APIs provide a standardized way for applications to access the functionality and services offered by remote systems, regardless of the programming languages, platforms, or technologies used by the client and server applications. This enables developers to build distributed systems and integrate disparate software components seamlessly, leveraging the capabilities of remote systems to enhance the functionality and performance of their applications.

Common examples of remote APIs include web APIs (e.g., RESTful APIs, SOAP APIs) used to access web services and cloud-based platforms, as well as proprietary APIs provided by software vendors for accessing their remote services or platforms. Remote APIs typically define a set of methods, data formats, and authentication mechanisms that clients must adhere to when making requests and processing responses.

Remote APIs play a crucial role in enabling modern software architectures such as microservices, client-server applications, and distributed systems. By providing a standardized and interoperable means of communication between applications, remote APIs facilitate seamless integration, interoperability, and scalability in complex software ecosystems spanning multiple platforms and environments.

In an embodiment of the disclosure, BMC 216 is configured to operate a remote API according to the Redfish standard. Redfish is an open standard, industry-standard specification developed by the Distributed Management Task Force (DMTF) for managing and monitoring modern server hardware in data centers and cloud environments. It provides a scalable and interoperable interface for remote management and monitoring of servers, networking devices, and other IT infrastructure components.

Redfish defines a RESTful API (Representational State Transfer) that allows administrators to interact with server hardware using standard HTTP(S) methods, such as GET, POST, PUT, and DELETE. This API enables administrators to perform a wide range of management tasks, including hardware configuration, firmware updates, power management, system inventory, and hardware health monitoring, all through a standardized and vendor-neutral interface.

One of the key advantages of Redfish is its simplicity and ease of use. By leveraging a RESTful API and standard web protocols, Redfish provides a user-friendly interface that is easy to integrate with existing management tools and automation frameworks. This makes it easier for administrators to automate common management tasks, create custom management applications, and integrate server management into broader IT management workflows.

Redfish is designed to be extensible and flexible, allowing vendors to define their own extensions and custom resources to address specific requirements or support proprietary features. This flexibility ensures that Redfish can adapt to evolving hardware architectures and accommodate the diverse needs of different hardware vendors and data center environments.

While certain embodiments utilize the Redfish standard, it will be understood that any remote API that supports an authentication system may be utilized.

If the authentication request is not approved, 312, BMC 216 returns an error message to gateway 208, 316, which gateway 208 returns to client 204, 320. Client 204 must then retry the authentication request with updated or corrected security information.

If the authentication request is approved at BMC 216, 312, BMC 216 generates a token 228 indicating that the authentication request has been approved and transmits the token 228 to the client, 328. The client is now able to use the token in connection with subsequent services queries to the system service, 332.

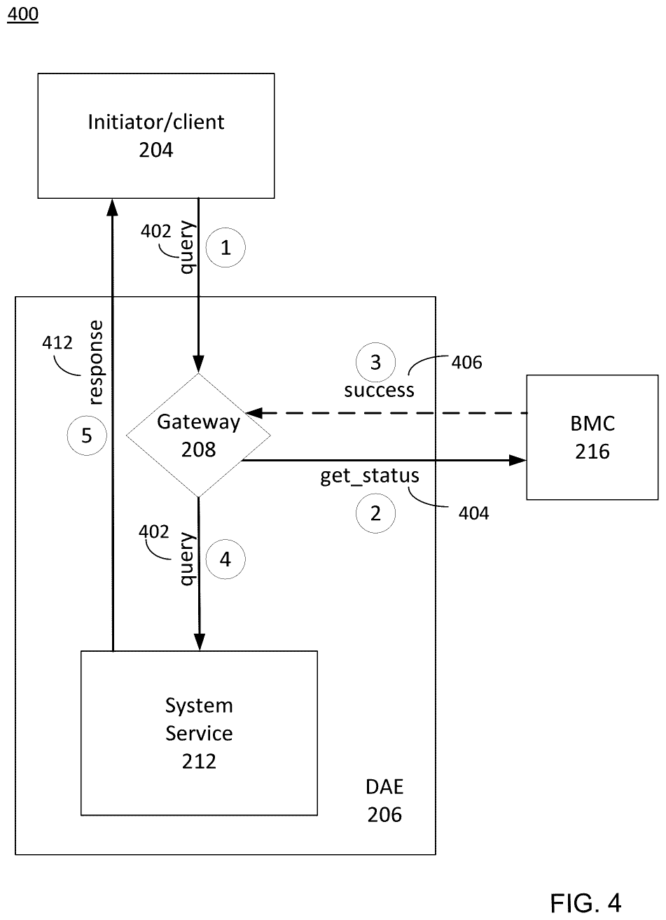

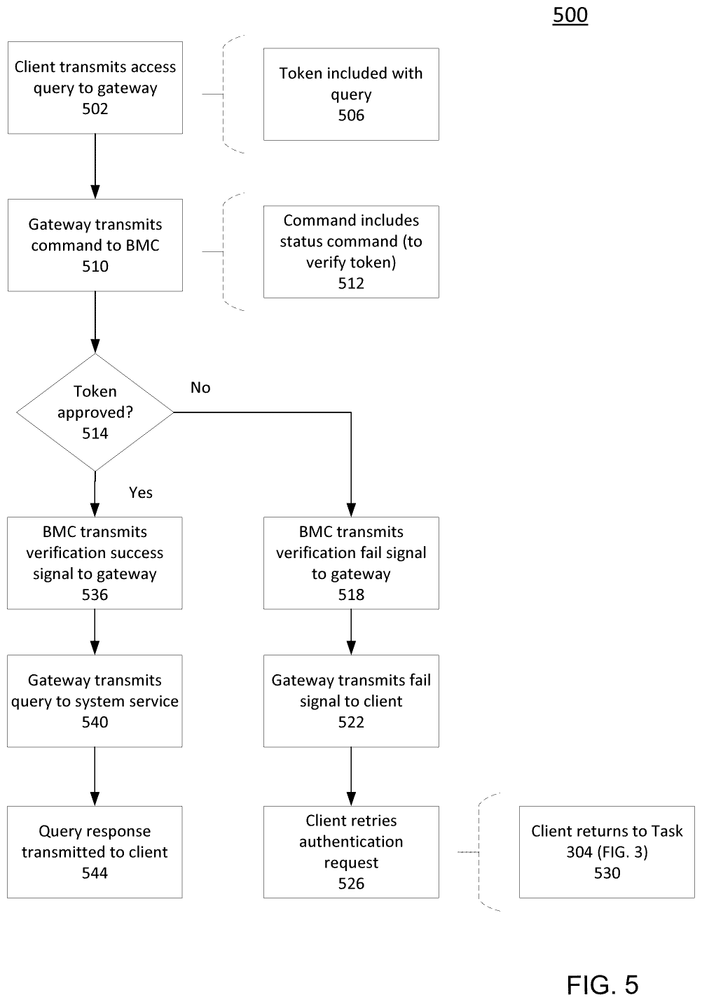

FIGS. 4 and 5 are a further example graphical representation 400 and a flowchart 500, respectively, of a system and process for offloading security functionality of a data storage system, in which the client has received a token indicating that the BMC 216 has approved its authentication request, as described with reference to FIGS. 2 and 3. At 502, client 204 transmits a query 402 to the gateway 208, in which the query requests a response from the system service 212 for a specified operation. The token 228 is included with the query 402, 506. The gateway 208 transmits a command 404 to BMC 216, 510. In an embodiment, command 404 is a generic NOP (keep alive/status) command which includes token 228, 512. When processing the command 404, the BMC 216 will determine whether the included token 228 remains approved, 514.

If the token is not approved, 514, meaning that the query 402 from the client 204 is not authorized, BMC 216 transmits a verification fail signal to gateway 208, 518, which gateway 208 transmits to client 204, 522. The client then retries the authentication request, 502, by returning to task 304 (FIG. 3), 530.

If the token is approved, 514, BMC 216 transmits a verification success signal 406 to gateway 208, 536, to indicate that the query has been approved for processing by the system service 212. Upon receiving the indication that the token associated with the query 402 has been authenticated, gateway 208 transmits the query to system service 212 for processing, 540. System service 212 then transmits the response 412 to client 204.

Accordingly, embodiments of the disclosure are directed to a system and method for remotely offloading security functionality of a data storage system to a baseboard management controller by creating a trusted connection between the gateway and the baseboard management controller. Since such system typically include a BMC to utilize many of its features described above, rather than implement a security function on the DAE itself, authentication functions are offloaded to the remote BMC for processing.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method, executed on a computing device, comprising:
receiving, at a gateway of a data storage system, an authentication request from a client for establishing a trusted connection between the client and the data storage system;
the gateway transferring the authentication request to a remote management system for processing by the remote management system;
upon approval of the authentication request, the gateway receiving an authentication token from the remote management system; and
the gateway transferring the authentication token to the client for use in subsequent access requests to the data storage system.

2. The computer-implemented method of claim 1 wherein the remote management system comprises a baseboard management controller (BMC).

3. The computer-implemented method of claim 1 wherein the gateway comprises a dedicated management interface.

4. The computer-implemented method of claim 3 wherein the dedicated management interface comprises a Redfish interface.

5. The computer-implemented method of claim 1 further comprising;
receiving, at the gateway, a query from the client, wherein the query includes the authentication token;
the gateway sending a command, including the authentication token, to the remote management system for verification;
upon verification of the authentication token, the gateway receiving a success message from the remote management system, indicating that the authentication token included with the query is verified; and
the gateway transmitting the query to access a service of the data storage system.

6. The computer-implemented method of claim 5 further comprising the service transmitting a response to the query to the client.

7. The computer-implemented method of claim 5 wherein the command comprises a status command.

8. The computer-implemented method of claim 1 wherein the remote management system comprises a remote application programming interface (API).

9. The computer-implemented method of claim 8 wherein the remote API comprises a RESTful API.

10. A computer program product residing on a non-transitory computer readable medium having a plurality of instructions stored thereon which, when executed by a processor, cause the processor to perform operations comprising:
receiving, at a gateway of a data storage system, a query from a client, wherein the query includes an authentication token;
the gateway sending a command, including the authentication token, to a remote management system for verification;
upon verification of the authentication token, the gateway receiving a success message from the remote management system, indicating that the authentication token included with the query is verified; and
the gateway transmitting the query to access a service of the data storage system.

11. The computer program product of claim 10 further comprising the service transmitting a response to the query to the client.

12. The computer program product of claim 10 wherein the command comprises a status command.

13. The computer program product of claim 10 wherein the remote management system comprises a remote application programming interface (API).

14. The computer-implemented method of claim 13 wherein the remote API comprises a RESTful API.

15. The computer program product of claim 10 further comprising receiving, at the gateway of the data storage system, an authentication request from the client for establishing a trusted connection between the client and the data storage system;
the gateway transferring the authentication request to the remote management system for processing by the remote management system;
upon approval of the authentication request, the gateway receiving the authentication token from the remote management system; and
the gateway transferring the authentication token to the client for use in subsequent access requests to the data storage system.

16. The computer program product of claim 15 wherein the remote management system comprises a baseboard management controller (BMC).

17. The computer program product of claim 15 wherein the gateway comprises a dedicated management interface.

18. The computer program product of claim 17 wherein the dedicated management interface comprises a Redfish interface.

19. A computing system comprising:
a memory; and
a processor configured to:
receive, at a gateway of a data storage system, an authentication request from a client for establishing a trusted connection between the client and the data storage system;
transferring the authentication request from the gateway to a remote management system for processing by the remote management system;
upon approval of the authentication request, the gateway receiving an authentication token from the remote management system
the gateway transferring the authentication token to the client for use in subsequent access requests to the data storage system;
receiving, at the gateway of the data storage system, a query from the client, wherein the query includes the authentication token;
the gateway sending a command, including the authentication token, to the remote management system for verification;
upon verification of the authentication token, the gateway receiving a success message from the remote management system, indicating that the authentication token included with the query is verified; and
the gateway transmitting the query to access a service of the data storage system.

20. The computing system of claim 19 wherein the remote management system comprises a baseboard management controller.
